(19) United States
(12) Patent Application Publication
(10) Pub. No.: US 2026/0252000 A1
(43) Pub. Date: Aug. 27, 2026

(54) SHEET-SHAPED SEALER, REMOVABLE UNIT, AND IMAGE FORMING APPARATUS

(71) Applicants: Kazuki MATSUMOTO, Kanagawa (JP); Shinichi KAWAHARA, Tokyo (JP)

(72) Inventors: Kazuki MATSUMOTO, Kanagawa (JP); Shinichi KAWAHARA, Tokyo (JP)

(73) Assignee: ETRIA CO., LTD., Yokohama (JP)

(21) Appl. No.: 19/445,043

(22) Filed: Jan. 9, 2026

(30) Foreign Application Priority Data
Feb. 25, 2025 (JP) 2025-027836

(51) Int. Cl. G03G 15/08; G03G 21/16; G03G 21/18

(52) U.S. Cl. CPC G03G 15/0882; G03G 21/1676; G03G 21/1814; G03G 21/1832; G03G 21/1839; G03G 2215/088; G03G 2221/163

(57) ABSTRACT

A sealer includes a sealing portion and a fixing portion. The sealing portion seals a supply port of a removable unit detachable from an apparatus in a pull-out direction. The fixing portion is on the removal unit to fix the sealer to the removable unit. The fixing portion is disposed upstream from the sealing portion in the pull-out direction.

### CROSS-REFERENCE TO RELATED APPLICATION

This patent application is based on and claims priority pursuant to 35 U.S.C. § 119(a) to Japanese Patent Application No. 2025-027836, filed on Feb. 25, 2025, in the Japan Patent Office, the entire disclosure of which is hereby incorporated by reference herein.

### BACKGROUND

### Technical Field

The present disclosure relates to a sheet-shaped sealer, a removable unit, and an image forming apparatus. The sheet-shaped sealer can be pulled out from the front side in a longitudinal direction of the removable unit as a pull-out direction. The removable unit is a unit such as a process cartridge and a developing device, which includes the sheet-shaped sealer. The image forming apparatus is an apparatus such as a copier, a printer, a facsimile machine, or a multifunction peripheral thereof.

### Related Art

In a removable unit such as a process cartridge or a developing device installed in an image forming apparatus such as a copying machine or a printer at the time of shipment, a sheet-shaped sealer is installed in order to seal a supply inlet for powder such as toner stored therein. When the removable unit of the image forming apparatus delivered to a user is started to be used, the sheet-shaped sealer is pulled out from the removable unit by an operator such as a user or a service person with a longitudinal direction of the removable unit as a pull-out direction. As a result, the supply inlet is opened, so that the powder such as the toner can be supplied.

### SUMMARY

The present disclosure described herein provides a sealer that includes a sealing portion and a fixing portion. The sealing portion seals a supply port of a removable unit detachable from an apparatus in a pull-out direction. The fixing portion is on the removal unit to fix the sealer to the removable unit. The fixing portion is disposed upstream from the sealing portion in the pull-out direction.

The present disclosure described herein also provides a removable unit that includes the sealer.

The present disclosure described herein further provides an image forming apparatus that includes the removable unit.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a diagram illustrating an image forming device of the image forming apparatus of FIG. 1;

FIG. 3 is a cross-sectional view of a main part of a process cartridge, cut along a longitudinal direction of a process cartridge;

FIG. 4A is a diagram illustrating a state in which a process cartridge having a sheet-shaped sealer according to a first embodiment is attached in the image forming apparatus at the time of shipment;

FIG. 4B is a diagram illustrating a state in which an opening-and-closing cover is opened;

FIG. 5 is a perspective view of a process cartridge at the time of shipment;

FIG. 6 is a top view of a sheet-shaped sealer according to the first embodiment;

FIG. 7A is a cross-sectional view illustrating a state in which a sheet-shaped sealer according to the first embodiment is adhered to a process cartridge;

FIG. 7B is a cross-sectional view illustrating a state in which a fixing portion of the sheet-shaped sealer according to the first embodiment is peeled off;

FIG. 7C is a cross-sectional view illustrating a state in which a sealing portion of the sheet-shaped sealer according to the first embodiment is detached;

FIG. 7D is a cross-sectional view illustrating a state in which a first double-sided tape of the sheet-shaped sealer according to the first embodiment is peeled off;

FIG. 7E is a cross-sectional view illustrating a state in which a second double-sided tape of the sheet-shaped sealer according to the first embodiment is peeled off;

FIG. 7F is a cross-sectional view illustrating a state in which a third double-sided tape of the sheet-shaped sealer according to the first embodiment is peeled off;

FIG. 8 is a cross-sectional view illustrating a state in which a sheet-shaped sealer according to a second embodiment is adhered to a process cartridge;

FIG. 9 is a cross-sectional view illustrating a state in which a sheet-shaped sealer according to a third embodiment is adhered to a process cartridge;

FIG. 10 is a cross-sectional view illustrating a state in which a sheet-shaped sealer according to a fourth embodiment is adhered to a process cartridge;

FIG. 11 is a cross-sectional view illustrating a state in which a sheet-shaped sealer according to a fifth embodiment is adhered to a process cartridge;

FIG. 12A is a perspective view illustrating a state in which a sheet-shaped sealer according to a sixth embodiment is adhered to a process cartridge;

FIG. 12B-a is a plan view of a tip portion of a sheet-shaped sealer according to the sixth embodiment;

FIG. 12B-b is a plan view illustrating a state in which cracks expand from slits as starting points;

FIG. 12C is a diagram illustrating the direction of the slits of the sheet-shaped sealer according to the sixth embodiment;

FIGS. 13 (a1) and 13 (a2) are cross-sectional views of a sealing portion of a sheet-shaped sealer according to a seventh embodiment;

FIGS. 13 (b1) and 13 (b2) are plan views of the sealing portion of the sheet-shaped sealer according to the seventh embodiment;

FIG. 14A is an enlarged view illustrating a state in which a sheet-shaped sealer is adhered to a process cartridge according to a first modification;

FIG. 14B is a top view of a fixed portion;

FIG. 15A is an enlarged view illustrating a state in which a sheet-shaped sealer is fixed to a process cartridge according to a second modification;

FIG. 15B is a top view illustrating a fixing portion of the sheet-shaped sealer;

FIG. 16 is a cross-sectional view illustrating a state in which a sheet-shaped sealer is adhered to a process cartridge according to a third modification;

FIG. 17 is a cross-sectional view illustrating a state in which a sheet-shaped sealer is adhered to a process cartridge according to a fourth modification; and

FIG. 18 is a cross-sectional view illustrating a state in which a sheet-shaped sealer according to a comparative example is adhered to a process cartridge.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Identical reference numerals are assigned to identical or equivalent components and a description of those components may be simplified or omitted. As used herein, the singular forms “a,” “an,” and “the” are intended to include the plural forms as well, unless the context clearly indicates otherwise.

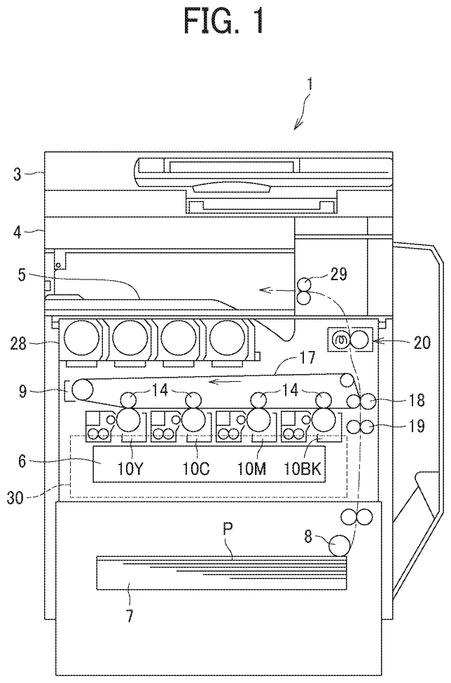

A description is given below of an overall configuration and operation of an image forming apparatus 1 with reference to FIG. 1. In FIG. 1, a body of the image forming apparatus 1, which is illustrated as a color copier in the present embodiment, includes a document conveying device 3, a scanner 4 (document reading device), and a writing device 6 (exposure device). The document conveying device 3 conveys documents to the scanner 4. The scanner 4 scans the documents to read image data. The writing device 6 emits a laser beam based on input image data.

The image forming apparatus 1 also includes a sheet feeder 7, process cartridges 10Y, 10C, 10M, and 10BK (removable units), an intermediate transfer belt 17, and a secondary transfer roller 18. The sheet feeder 7 stores sheets P such as sheets of paper. The process cartridges 10Y, 10C, 10M, and 10BK are image forming devices to form toner images of yellow, magenta, cyan, and black, respectively. The toner images of multiple colors are transferred and superimposed one on another onto the intermediate transfer belt 17. The secondary transfer roller 18 transfers the toner images on the intermediate transfer belt 17 onto the sheet P. The image forming apparatus 1 further includes a fixing device 20, toner containers 28, and a waste-toner collection container 30. The fixing device 20 fixes unfixed toner images on the sheet P. The toner containers 28 contain toners of respective colors to be supplied to developing devices 13 of the corresponding process cartridges 10Y, 10C, 10M, and 10BK (the removable units). Waste-toner is collected in the waste-toner collection container 30.

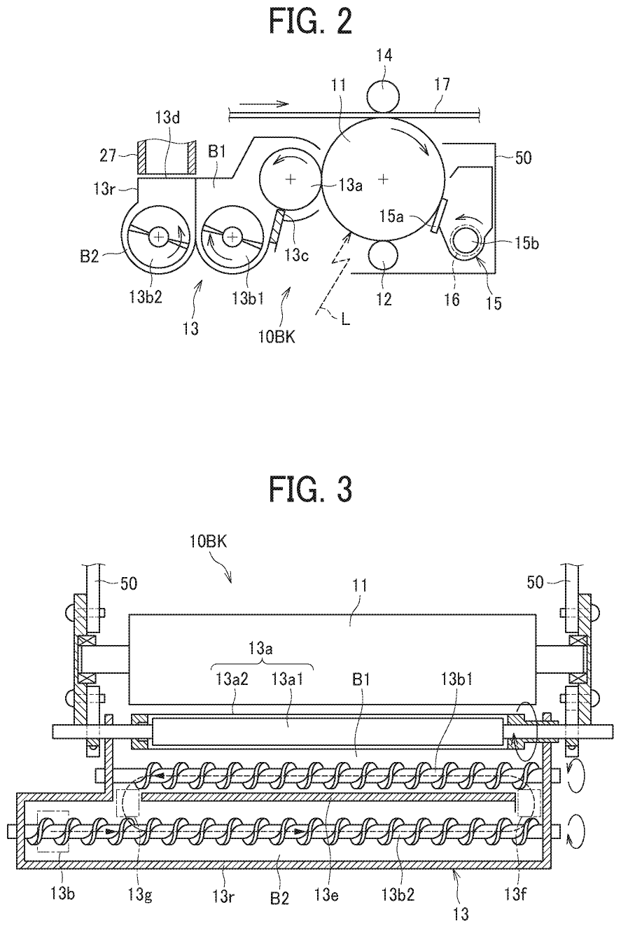

Each of the process cartridges 10Y, 10C, 10M, and 10BK (serving as four removable units) includes a photoconductor drum 11 (serving as an image bearer), a charging device 12, the developing device 13, and a cleaning device 15, which are united as a single unit as illustrated in FIG. 2. Each of the process cartridges 10Y, 10C, 10M, and 10BK is detachably attached to the body of the image forming apparatus 1.

Each of the process cartridges 10Y, 10C, 10M, and 10BK, which is expendable, is replaced with a new one when depleted. Yellow, magenta, cyan, and black toner images are formed on the respective photoconductor drums 11 (serving as image bearers) in the process cartridges 10Y, 10C, 10M, and 10BK.

A description is given below of operations of the image forming apparatus 1 to form a normal color toner image. Conveying rollers of the document conveying device 3 convey a document on a document table onto an exposure glass of the scanner 4. The scanner 4 optically scans the document on the exposure glass to read image data.

The yellow, magenta, cyan, and black image data are transmitted to the writing device 6. The writing device 6 irradiates the photoconductor drums 11 of the corresponding process cartridges 10Y, 10C, 10M, and 10BK with laser beams L (exposure light) based on the yellow, magenta, cyan, and black image data, respectively.

Meanwhile, the four photoconductor drums 11 rotate clockwise as illustrated in FIGS. 1 and 2. With reference to FIG. 2, the charging device 12 (a charging roller) uniformly charges a surface of the photoconductor drum 11 at a position opposite the photoconductor drum 11 (a charging process). Thus, the surface of the photoconductor drum 11 is charged to a certain potential.

Subsequently, the surface of the photoconductor drum 11 thus charged reaches a position where the surface of the photoconductor drum 11 is irradiated with the laser beam L. The writing device 6 emits, from a light source, the laser beams L for respective colors according to the image data of respective colors.

The laser beams L are reflected by a polygon mirror and transmitted through multiple lenses. The laser beams L transmitted through the multiple lenses pass through different optical passages for the different color components of yellow, magenta, cyan, and black (an exposure process).

The laser beam L corresponding to the yellow image data is emitted to the surface of the photoconductor drum 11 in the first process cartridge 10Y from the left among the four process cartridges 10Y, 10C, 10M, and 10BK in FIG. 1. Thus, an electrostatic latent image for yellow is formed on the photoconductor drum 11 charged by the charging device 12.

Similarly, the laser beam L corresponding to the cyan image data is emitted to the surface of the photoconductor drum 11 in the second process cartridge 10C from the left in FIG. 1, thus forming an electrostatic latent image corresponding to the cyan image data on the surface of the photoconductor drum 11. The laser beam L corresponding to the magenta image data is emitted to the surface of the photoconductor drum 11 in the third process cartridge 10M from the left in FIG. 1, thus forming an electrostatic latent image corresponding to the magenta image data on the surface of the photoconductor drum 11. The laser beam L corresponding to black image data is emitted to the surface of the photoconductor drum 11 in the fourth process cartridge 10BK from the left in FIG. 1, thus forming an electrostatic latent image corresponding to the black image data on the surface of the photoconductor drum 11.

Then, the surface of the photoconductor drum 11 bearing the electrostatic latent image for each color reaches the position opposite the developing device 13 (the process cartridge 10BK, see FIG. 2). The developing device 13 supplies toner of each color onto the surface of the photoconductor drum 11 and develops the electrostatic latent image on the photoconductor drum 11 into a toner image (a development process).

Subsequently, the surface of the photoconductor drum 11 after the development process reaches a position opposite the intermediate transfer belt 17 (intermediate transferor) as an image bearer. Primary transfer rollers 14 are disposed at the positions where the surfaces of the photoconductor drums 11 face the intermediate transfer belt 17 such that the primary transfer rollers 14 contact an inner circumferential surface of the intermediate transfer belt 17. At the positions of the primary transfer rollers 14, the toner images on the photoconductor drums 11 are sequentially transferred and superimposed onto the intermediate transfer belt 17, forming a multicolor toner image thereon (a primary transfer process).

After the primary transfer process, the surface of the photoconductor drum 11 reaches the position opposite the cleaning device 15 (see FIG. 2). The cleaning device 15 collects untransferred toner remaining on the photoconductor drum 11 (a cleaning process).

The untransferred toner collected in the cleaning device 15 is conveyed in a conveyance tube 16 by a conveying screw 15b (see FIG. 2) and is collected as waste toner in a waste-toner collection container 30. Then, the surface of the photoconductor drum 11 passes through a charge elimination device to complete a series of image forming processes performed on the photoconductor drum 11.

Meanwhile, the surface of the intermediate transfer belt 17, onto which the single-color toner images on the photoconductor drums 11 are transferred and superimposed, moves in a direction indicated by an arrow in FIG. 1 and reaches a position opposite a secondary transfer roller 18. The secondary transfer roller 18 secondarily transfers the multicolor toner image on the intermediate transfer belt 17 onto the sheet P (a secondary transfer process).

After the secondary transfer process, the surface of the intermediate transfer belt 17 reaches a position opposite an intermediate transfer belt cleaner 9 (a cleaning device for the intermediate transfer belt 17). The intermediate transfer belt cleaner 9 collects the untransferred toner on the intermediate transfer belt 17 to complete a series of transfer processes on the intermediate transfer belt 17. The untransferred toner collected in the intermediate transfer belt cleaner 9 is conveyed in the conveyance tube 16 by the conveying screw 15b (see FIG. 2) and is collected as waste toner in the waste-toner collection container 30.

The sheet P is conveyed from the sheet feeder 7 to the position of the secondary transfer roller 18 via, for example, a sheet conveyance guide and a registration roller pair 19. More specifically, a feed roller 8 feeds the sheet P from the sheet feeder 7 that stores a stack of sheets P, and the sheet P is then guided by the sheet conveyance guide to the registration roller pair 19. The sheet P that has reached the registration roller pair 19 is conveyed toward the position of the secondary transfer roller 18 at a timing at which the sheet P can receive the multicolor toner image on the intermediate transfer belt 17.

Subsequently, the sheet P, onto which the multicolor toner image is transferred, is conveyed to a fixing device 20. The fixing device 20 includes a fixing roller and a pressure roller pressing against each other. In a nip between the fixing roller and the pressure roller, the multicolor toner image is fixed on the sheet P. After the fixing process, an output roller pair 29 ejects the sheet P as an output image to the exterior of the body of the image forming apparatus 1, and the ejected sheets P are stacked on an output tray 5 to complete a series of image forming processes.

Next, with reference to FIGS. 2 and 3, a description is given in detail below of image forming devices of the image forming apparatus. FIG. 2 is a schematic view of the process cartridge 10BK (removable unit) for black. The other three process cartridges 10Y, 10C, and 10M (removable units) have a similar configuration as the process cartridge 10BK for black except for the color of toner used in the image forming process, and thus drawings and descriptions thereof are omitted to avoid redundancy.

As illustrated in FIG. 2, the process cartridge 10BK as the removable unit includes the photoconductor drum 11 as the image bearer, the developing device 13, the charging device 12, and the cleaning device 15, which are stored in a cartridge casing 50 (a housing) as a single unit. The cleaning device 15 includes a cleaning blade 15a and the conveying screw 15b that contact the photoconductor drum 11.

The developing device 13 includes a developing roller 13a (serving as a developer bearer) disposed opposite the photoconductor drum 11 to form a developing area, a first conveying screw 13b1 (serving as a first conveyor) disposed opposite the developing roller 13a, a partition 13e, a second conveying screw 13b2 (serving as a second conveyor) disposed opposite the first conveying screw 13b1 via the partition 13e, and a doctor blade 13c (serving as a developer regulator) disposed opposite the developing roller 13a to regulate the amount of developer borne on the developing roller 13a.

The developing device 13 stores two-component developer including toner and carrier. The developing roller 13a faces the photoconductor drum 11 with a small gap, thereby forming a developing area. As illustrated in FIG. 3, the developing roller 13a includes a magnet 13a1 secured inside and a sleeve 13a2 that rotates around the magnet 13a1. The magnet 13a1 generates multiple poles (magnetic poles) around an outer circumferential surface of the developing roller 13a.

The first conveying screw 13b1 (serving as the first conveyor) and the second conveying screw 13b2 (serving as the second conveyor) convey the developer stored in the developing device 13 in the longitudinal direction of the developing device 13, thereby forming a circulation passage indicated by the dashed arrow in FIG. 3. In other words, the circulation passage of the developer includes a first conveyance passage B1 with the first conveying screw 13b1 and a second conveyance passage B2 with the second conveying screw 13b2.

The partition 13e is an inner wall and separates the first conveyance passage B1 from the second conveyance passage B2. The first conveyance passage B1 and the second conveyance passage B2 communicate with each other via a first communication opening 13f and a second communication opening 13g disposed at both longitudinal ends of the first conveyance passage B1 and the second conveyance passage B2. Specifically, with reference to FIG. 3, an upstream end of the first conveyance passage B1 in a conveyance direction of the developer communicates with a downstream end of the second conveyance passage B2 in the conveyance direction via the first communication opening 13f.

On the other hand, a downstream end of the first conveyance passage B1 in the conveyance direction communicates with an upstream end of the second conveyance passage B2 in the conveyance direction via the second communication opening 13g. In other words, the partition 13e is disposed along the circulation passage except both longitudinal ends of the circulation passage.

The first conveying screw 13b1 (or the first conveyance passage B1) is disposed to face the developing roller 13a. The second conveying screw 13b2 (or the second conveyance passage B2) is disposed to face the first conveying screw 13b1 (or the first conveyance passage B1) via the partition 13e. The first conveying screw 13b1 supplies developer toward the developing roller 13a and collects the developer separated from the developing roller 13a after the development process while conveying the developer in the longitudinal direction of the developing device 13.

The second conveying screw 13b2 stirs and mixes the developer after the development process conveyed from the first conveyance passage B1 with fresh developer supplied from a supply port 13d as a powder supply inlet while conveying the developer and the fresh developer in the longitudinal direction of the developing device 13. In the present embodiment, the first conveying screw 13b1 and the second conveying screw 13b2 (conveyors) are horizontally arranged in parallel. Each of the first conveying screw 13b1 and the second conveying screw 13b2 includes a shaft and a screw blade wound around the shaft.

A description is given in further detail of the image forming processes described above, focusing on the development process. The developing roller 13a rotates in the direction indicated by an arrow in FIG. 2. As illustrated in FIG. 3, the first conveying screw 13b1 and the second conveying screw 13b2 are disposed with the partition 13e interposed therebetween and rotate in the directions indicated by arrows in FIGS. 2 and 3. Toner is supplied from a toner container 28 to the supply port 13d (an inlet port) through a toner supply passage via a toner discharge port 27. As the first conveying screw 13b1 and the second conveying screw 13b2 rotate in the respective directions in FIG. 2, the developer stored in the developing device 13 circulates together with the supplied toner in the longitudinal direction of the developing device 13 (i.e., the circulation in the direction indicated by the dashed arrow in FIG. 3) while being stirred and mixed with the supplied toner. The supply port 13d of the developing device 13 communicates with and is released from the toner discharge port 27 of the toner supply passage of the body of the image forming apparatus 1 in conjunction with the attachment or detachment operation of the developing device 13 (i.e., the process cartridge 10BK) with respect to the body of the image forming apparatus 1.

The toner is charged by friction with carrier in the developer and electrostatically attracted to carrier. Then, the toner is scooped up onto the developing roller 13a together with carrier by a developer scooping pole generated on the developing roller 13a. The developer borne on the developing roller 13a is conveyed in the counterclockwise direction indicated by the arrow in FIG. 2 to a position opposite the doctor blade 13c.

The doctor blade 13c adjusts the amount of the developer on the developing roller 13a to a proper amount at this position. Subsequently, the rotation of the sleeve 13a2 of the developing roller 13a conveys the developer to the developing area in which the developing roller 13a faces the photoconductor drum 11. Then, the toner in the developer is attracted to the electrostatic latent image formed on the photoconductor drum 11 due to the effect of an electric field generated in the developing area.

As the sleeve 13a2 rotates, the developer remaining on the developing roller 13a reaches above the first conveyance passage B1 and is separated from the developing roller 13a. The electric field in the developing area is generated by a specified voltage (i.e., a development bias) applied to the developing roller 13a by a development power supply and a surface potential (i.e., a latent image potential) formed on the surface of the photoconductor drum 11 in the charging process and the exposure process.

The toner in the toner container 28 is supplied through the supply port 13d into the developing device 13 as the toner in the developing device 13 is consumed. The toner consumption in the developing device 13 is detected by a toner concentration sensor that magnetically detects a toner concentration in the developer (i.e., a ratio of toner to the developer) in the developing device 13. The supply port 13d is disposed above an end of the second conveying screw 13b2 (the second conveyance passage B2) in the longitudinal direction (the left-and-right direction in FIG. 3).

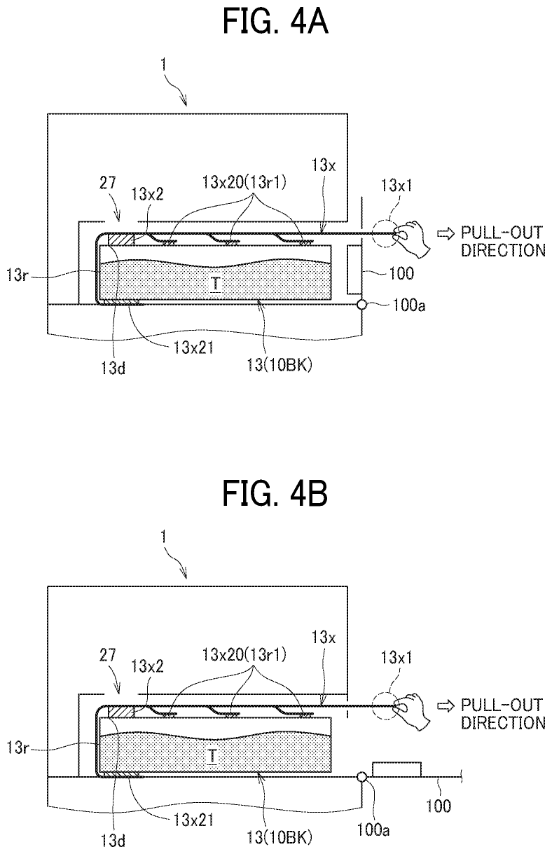

A description is given below in detail of a characteristic configuration and operation of the process cartridge 10BK as the removable unit in the present embodiment with reference to FIGS. 4A to 7F. With reference to FIGS. 4A and 4B, the process cartridge 10BK in the present embodiment functions as the removable unit detachably attached in the body of the image forming apparatus 1. The process cartridge 10BK (removable unit) is installed inside the body of the image forming apparatus 1 (at an installation position where an image forming process is performed) in a state where the developer is stored (preset) in the developing device 13 in advance at the time of shipment from a factory.

As described above with reference to FIGS. 2 and 3, the developing device 13 of the process cartridge 10BK has the supply port 13d as an opening portion for appropriately supplying toner from the toner container 28 into the developing device 13. Accordingly, if the developing device 13 is set in the body of the image forming apparatus 1 and shipped from a factory with the supply port 13d (opening portion) remaining open, the developer preset in the developing device 13 may leak from the supply port 13d due to vibration during transportation.

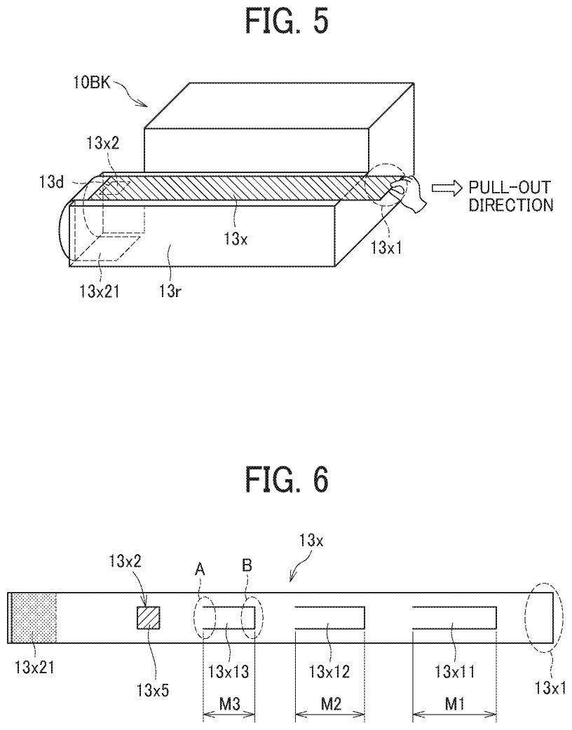

Accordingly, in the present embodiment, as illustrated in FIGS. 4A, 4B, and 5, the supply port 13d (opening portion) of the developing device 13 (process cartridge 10BK) is sealed as a sealed portion by a sheet-shaped sealer 13x at the time of shipment from a factory. Such a configuration prevents an inconvenience that the developer preset in the developing device 13 of the body of the image forming apparatus 1 shipped from a factory scatters in the image forming apparatus 1 during transportation.

The sheet-shaped sealer 13x is detachably attached to the process cartridge 10BK (removable unit). When the process cartridge 10BK (developing device 13) is started to be used in the body of the image forming apparatus 1 arrived to a user, the sheet-shaped sealer 13x is pulled out (removed) from the process cartridge 10BK in the direction of the white arrow by an operator such as the user or a service person, with the longitudinal direction (the left-and-right direction in FIGS. 4A and 4B) as a pull-out direction.

Specifically, as illustrated in FIGS. 4A and 4B, the body of the image forming apparatus 1 includes an opening-and-closing cover 100 that is openable and closable for attachment and detachment of the process cartridge 10BK (removable unit). The opening-and-closing cover 100 is rotated around a support shaft 100a in the clockwise direction in FIGS. 4A and 4B to open the inside of the image forming apparatus 1. The opening-and-closing cover 100 is rotated around the support shaft 100a in the counterclockwise direction in FIGS. 4A and 4B to close the inside of the body of the image forming apparatus 1. The process cartridge 10BK is attached to the body of the image forming apparatus 1 from the right side to the left side in FIG. 4 and is pulled out in the opposite direction.

On the other hand, the sheet-shaped sealer 13x installed in the process cartridge 10BK (developing device 13) at the time of shipment from a factory has a grip 13x1 that can be gripped and pulled out by an operator on the front side in the pull-out direction (the right side in FIGS. 4A and 4B). As illustrated in FIG. 4A, in the process cartridge 10BK set in the body of the image forming apparatus 1 at the time of shipment from a factory, the grip 13x1 is exposed to be pulled out to the outside of the body of the image forming apparatus 1 via an opening portion formed in the opening-and-closing cover 100 in a state where the opening-and-closing cover 100 is closed.

When an operator starts using the process cartridge 10BK in the body of the image forming apparatus 1 after the arrival of the image forming apparatus 1, the operator pulls out the sheet-shaped sealer 13x in the direction of the white arrow in FIG. 4A to open the supply port 13d in the sealed state. With such a configuration, an operator can pull out and remove the sheet-shaped sealer 13x without taking out the process cartridge 10BK from the body of the image forming apparatus 1.

As illustrated in FIG. 4B, the grip 13x1 may be exposed to the outside of the body of the image forming apparatus 1 in a state where the opening-and-closing cover 100 is opened so that the grip 13x1 can be pulled out from the body of the image forming apparatus 1. In such a case, when the operator starts using the process cartridge 10BK in the body of the image forming apparatus 1 after the arrival of the image forming apparatus 1, the operator opens the opening-and-closing cover 100 and grips the grip 13x1 to pull out the sheet-shaped sealer 13x in the direction of the white arrow in FIG. 4B to open the supply port 13d in the sealed state.

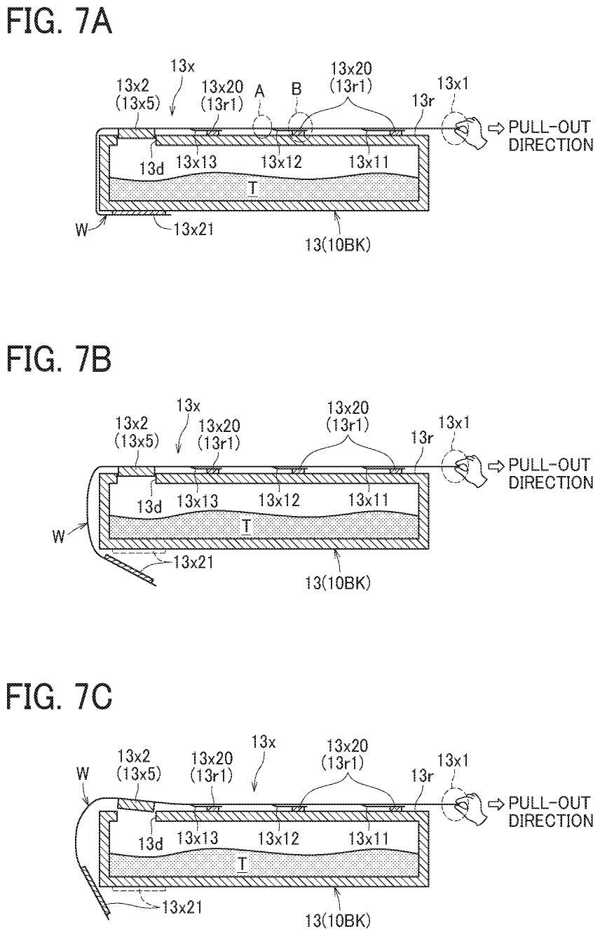

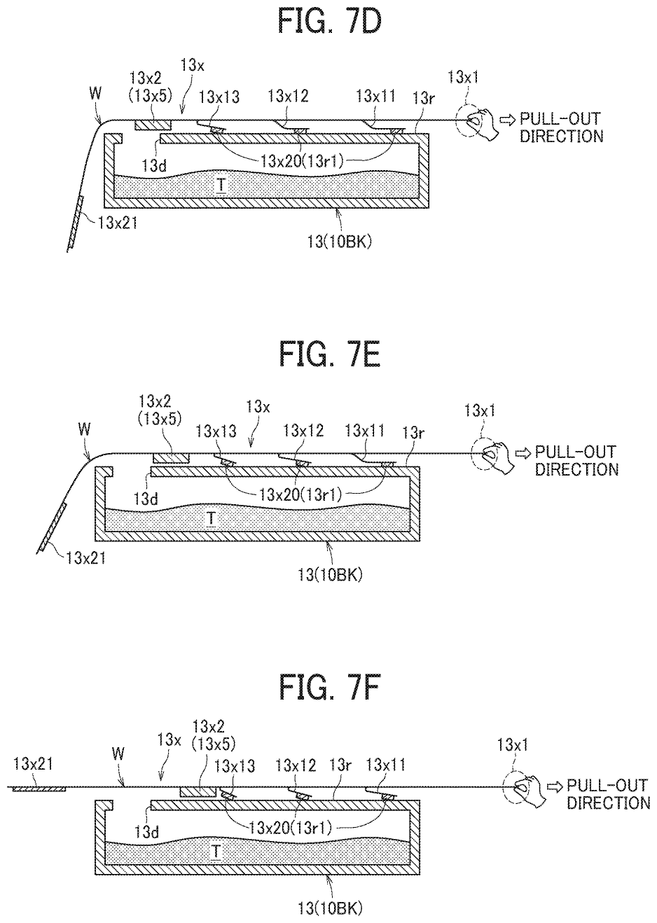

As described above, the sheet-shaped sealer 13x in the present embodiment is formed to be pulled out from the front side in the pull-out direction (front side in FIGS. 4A and 4B) with the longitudinal direction (left-and-right direction in FIGS. 4A and 4B) as the pull-out direction. With reference to FIGS. 6, 7A, 7B, 7C, 7D, 7E, and 7F, the sheet-shaped sealer 13x is a sheet-shaped member made of a urethane sheet having a substantially rectangular main portion. In addition to the grip 13x1, for example, a sealing portion 13x2, cutout portions 13x11, 13x12, and 13x13, and a fixing portion 13x21, are formed in the sheet-shaped member. As described above, the grip 13x1 is formed on the front side in the pull-out direction (the right side in FIGS. 4A, 4B, 6, 7A, 7B, 7C, 7D, 7E, and 7F) so that an operator can grip and pull out the grip 13x1.

With reference to FIGS. 6, 7A, 7B, 7C, 7D, 7E, and 7F, the sealing portion 13x2 is for sealing the supply port 13d (an opening portion for allowing toner as powder to flow in) as the sealed portion. Specifically, an elastic member 13x5 to be press-fitted into the supply port 13d (opening portion) is provided on the back surface of the sealing portion 13x2.

A columnar member made of an elastic material such as foamed polyurethane can be used as the elastic member 13x5. The columnar member is pushed and fitted in the supply port 13d to seal the supply port 13d. The elastic member 13x5 is bonded and fixed to the front surface of the sheet-shaped sealer 13x (sealing portion 13x2) via, for example, a double-sided tape.

In the present embodiment, the supply port 13d is positioned on the rear side of the body of the image forming apparatus 1 (the downstream side in the attachment direction of the process cartridge 10BK and the side corresponding to the rear side in the pull-out direction of the sheet-shaped sealer 13x). Accordingly, the sheet-shaped sealer 13x is preferably formed such that the sealing portion 13x2 is located at a position corresponding to the rear side of the body of the image forming apparatus 1, and the length of the sheet-shaped sealer 13x (the length from the grip 13x1 to the sealing portion 13x2) is long in the longitudinal direction (the pull-out direction).

As illustrated in the FIGS. 7A, 7B, 7C, 7D, 7E, and 7F, the sheet-shaped sealer 13x is provided with the fixing portion 13x21 at the end of the sheet-shaped sealer 13x on the back side in the pull-out direction. As illustrated in FIG. 7A, the sheet-shaped sealer 13x is provided with the fixing portion 13x21 at a folded end of the lower surface of a developing case 13r at a folded portion W on the back side in the pull-out direction. The fixing portion 13x21 is bonded and fixed to the lower surface of the developing case 13r by, for example, a double-sided tape. The fixing portion 13x21 and the sealing portion 13x2 are attached to the developing case 13r in a state where the sheet-shaped sealer 13x between the fixing portion 13x21 and the sealing portion 13x2 is kept in a tensed state.

The elastic member 13x5 of the sealing portion 13x2 is positioned on the back side in the pull-out direction of the sheet-shaped sealer 13x. The elastic member 13x5 is fitted in the supply port 13d. When the sheet-shaped sealer 13x is pulled out in the direction indicated by the white arrow, first, the fixing portion 13x21 is peeled off from the lower surface of the developing case 13r. This is because the sheet-shaped sealer 13x between the fixing portion 13x21 and the sealing portion 13x2 is kept in a tensed state, and thus, a force for pulling out the sheet-shaped sealer 13x in the direction indicated by the white arrow immediately acts on the fixing portion 13x21.

Immediately after the fixing portion 13x21 is peeled, the elastic member 13x5 of the sealing portion 13x2 is detached from the supply port 13d. In this way, the fixing portion 13x21 and the elastic member 13x5 are separated from the developing case 13r with a slight time difference, so that an increase in the pull-out resistance of the sheet-shaped sealer 13x can be prevented, and the operability at the time of pulling-out can be enhanced.

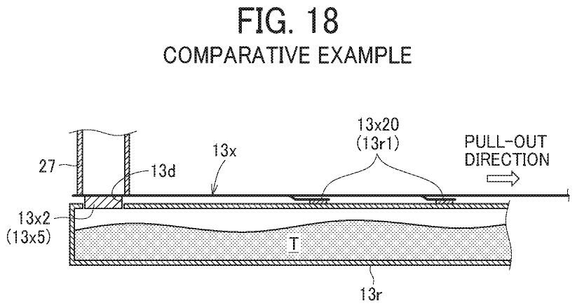

As illustrated in FIG. 18, the sheet-shaped sealer 13x in the comparative example does not have a fixing portion of the sheet-shaped sealer 13x on the back side in the pull-out direction with respect to the sealing portion 13x2. For this reason, when the developing case 13r is inserted into the body of the image forming apparatus 1 from the right side to the left side in FIG. 18, the sealing portion 13x2 interferes with the toner discharge port 27 on the body of the image forming apparatus 1, and thus, the sealing portion 13x2 is detached, so that there may be a risk that the toner T inside the developing case 13r leaks.

In the present embodiment, the lifting of the sealing portion 13x2 is prevented by the fixing portion 13x21, so that the interference of the sealing portion 13x2 with the toner discharge port 27 can be avoided when the developing case 13r is inserted into the body of the image forming apparatus 1. The toner discharge port 27 may be formed of a sponge-like elastic member.

The upper surface of the sealing portion 13x2 is lightly pressed with the sponge-like elastic member 13x5, so that the positional deviation of the sealing portion 13x2 can be restricted. The sealing property between the toner discharge port 27 and the supply port 13d can be maintained by the sponge-like elastic member 13x5 when the sheet-shaped sealer 13x is pulled out.

With reference to FIGS. 6, 7A, 7B, 7C, 7D, 7E, and 7F, the three cutout portions 13x11, 13x12, and 13x13 are cut out to be cantilevered with a position different from the sealing portion 13x2 as a root A. Specifically, the cutout portions 13x11, 13x12, and 13x13 are formed between the sealing portion 13x2 and the grip 13x1 in the pull-out direction. In particular, a plurality of cutout portions (three cutout portions 13x11, 13x12, and 13x13 in the present embodiment) are formed at intervals in the pull-out direction.

Each of the three cutout portions 13x11, 13x12, and 13x13 is formed in a substantially U-shape (substantially strip-shape) with the root A extending linearly in a direction (lateral direction) orthogonal to the pull-out direction (longitudinal direction) as a starting point. A free end of each of the cutout portions 13x11, 13x12, and 13x13 is removably fixed as a fixing portion B to a fixed portion 13r1 of a housing (a developing case 13r of the developing device 13 which is a part of the process cartridge 10BK) in which the supply port 13d (sealed portion) and the sheet-shaped sealer 13x are installed.

Specifically, the fixing portion B of each of the cutout portions 13x11, 13x12, and 13x13 includes a double-sided tape 13x20 on a surface opposite the fixed portion 13r1 of the developing case 13r. One side of the double-sided tape 13x20 is adhered to the fixing portion B, and the other side of the double-sided tape 13x20 is adhered to the fixed portion 13r1, and thus the fixing portion B is fixed to the fixed portion 13r1.

As illustrated in FIG. 7, the fixing portion B is fixed to the developing case 13r in a state where each of the cutout portions 13x11, 13x12, and 13x13 is bent at the root A. The strength (adhesive strength) with which each of the cutout portions 13x11, 13x12, and 13x13 (fixing portion B) is fixed to the fixed portion 13r1 is such that each of the cutout portions 13x11, 13x12, and 13x13 is relatively easily separated from the fixed portion 13r1 when an operator grips and pulls out the grip 13x1 and is such that each of the cutout portions 13x11, 13x12, and 13x13 is not easily separated even when the environmental condition such as temperature and humidity changes during transportation. As described above, the sheet-shaped sealer 13x in the present embodiment has the cutout portions 13x11, 13x12, and 13x13 fixed to the housing of the developing device 13 (process cartridge 10BK), and thus, operability at the time of pulling out can be enhanced.

Specifically, in a case where the cutout portions 13x11, 13x12, and 13x13 are not provided, when the sheet-shaped sealer 13x installed in the developing device 13 (process cartridge 10BK) is pulled out, the position of the sheet-shaped sealer 13x is not determined for a reason such as the shift of the sheet-shaped sealer 13x in the lateral direction orthogonal to the pull-out direction. Thus, the sheet-shaped sealer 13x may be difficult to pull or may be hooked on another member in an adjacent device to be broken. In such a case, the developing device 13 (process cartridge 10BK) may not be normally started to be used.

In addition, in a case where the cutout portions 13x11, 13x12, and 13x13 are not provided, when an operator assembles the sheet-shaped sealer 13x to the developing device 13 (process cartridge 10BK)) before shipment in a manufacturing plant, the position of the sheet-shaped sealer 13x in the lateral direction or the longitudinal direction is not determined, and the sheet-shaped sealer 13x is assembled in a state where floating or loosening occurs. In such a case, toner may leak from the supply port 13d of the developing device 13 (process cartridge 10BK) during transportation after shipment from a factory, or the operability during the pull-out operation after arrival may be deteriorated.

In particular, the inconveniences may not be negligible in the sheet-shaped sealer 13x whose length in the pull-out direction from the sealing portion 13x2 to the grip 13x1 is long. On the other hand, the sheet-shaped sealer 13x in the present embodiment has the cutout portions 13x11, 13x12, and 13x13 fixed to the housing of the developing device 13 (process cartridge 10BK), and thus the occurrence of the above-described inconveniences can be reduced. In the present embodiment, three cutout portions 13x11, 13x12, and 13x13 are formed in the sheet-shaped sealer 13x. However, the number of cutout portions is not limited thereto, and can be an optimal number according to the length in the pull-out direction.

With reference to FIG. 7, in the cutout portions 13x11, 13x12, and 13x13, the root A is positioned on the rear side in the pull-out direction (the left side in FIG. 7), and the fixing portion B is positioned on the front side in the pull-out direction (the right side in FIGS. 7A, 7B, 7C, 7D, 7E, and 7F). With such a configuration, when an operator pulls out the sheet-shaped sealer 13x, the sheet-shaped sealer 13x receives the repulsive force on the separation of the sealing portion 13x2 from the supply port 13d, and then receives the repulsive force on the separation of the fixing portion B from the fixed portion 13r1 at a different timing. Accordingly, the operability at the time of the pull-out operation can be enhanced as compared with the case where the above-described repulsive forces are received at the same timing.

In the present embodiment, the plurality of cutout portions 13x11, 13x12, and 13x13 are formed such that the length M from the root A to the fixing portion B is longer on the front side in the pull-out direction (the right side of FIGS. 6, 7A, 7B, 7C, 7D, 7E, and 7F) than on the back side in the pull-out direction (the left side of FIGS. 6, 7A, 7B, 7C, 7D, 7E, and 7F). Specifically, a length M1 of a first cutout portion 13x11 positioned closest to the grip 13x1 is the longest, a length M2 of a second cutout portion 13x12 positioned at the center of the sheet-shaped sealer 13x is medium, and a length M3 of a third cutout portion 13x13 positioned closest to the sealing portion 13x2 is the shortest (M1>M2>M3).

With such a configuration, when an operator pulls out the sheet-shaped sealer 13x, the sheet-shaped sealer 13x receives the repulsive force on the separation of the sealing portion 13x2 from the supply port 13d. Thereafter, the sheet-shaped sealer 13x receives a repulsive force when the fixing portion B of the third cutout portion 13x13 is separated from the fixed portion 13r1 at a different timing.

Thereafter, the sheet-shaped sealer 13x receives a repulsive force when the fixing portion B of the second cutout portion 13x12 is separated from the fixed portion 13r1. Finally, the sheet-shaped sealer 13x receives a repulsive force when the fixing portion B of the first cutout portion 13x11 is separated from the fixed portion 13r1.

Accordingly, the operability at the time of the pull-out operation can be enhanced as compared with the case where the above-described repulsive forces are received at the same timing. In particular, the sheet-shaped sealer 13x receives the repulsive forces in order from the repulsive force on the rear side in the pull-out direction (the side closer to the sealing portion 13x2) to the repulsive force on the front side, and thus a smooth pull-out feeling is generated.

The sheet-shaped sealer 13x in the present embodiment is formed such that the adhesive force of the double-sided tape 13x20 to the fixed portion 13r1 of the developing case 13r is smaller than the adhesive force of the double-sided tape 13x20 to the fixing portion B. Such a configuration can reduce inconveniences that the adhesive of the double-sided tape 13x20 remains on the fixed portion 13r1 when an operator pulls out the sheet-shaped sealer 13x. Further, the pull-out operability is also enhanced.

Next, a description is given of a state of pulling out the sheet-shaped sealer 13x in order with reference to FIGS. 7A, 7B, 7C, 7D, 7E, and 7F. FIG. 7A illustrates s a state in which a force in the pull-out direction is not yet applied to the sheet-shaped sealer 13x.

When a user holds the grip 13x1 and pulls out the sheet-shaped sealer 13x in the direction of the white arrow from the state illustrated in FIG. 7A, first, the fixing portion 13x21 at the tip of the sheet-shaped sealer 13x is peeled off from the lower surface of the developing case 13r.

When the sheet-shaped sealer 13x is further pulled out, the elastic member 13x5 of the sealing portion 13x2 comes off from the supply port 13d as illustrated in FIG. 7C. When the sheet-shaped sealer 13x is further pulled out, the fixing portion B of the first cutout portion 13x13 and the fixing portion B of the second cutout portion 13x12 are peeled off in order as illustrated in FIGS. 7D and 7E.

Finally, as illustrated in FIG. 7F, the fixing portion B of the third cutout portion 13x11 is peeled off. In this manner, all the fixing portions B between the cutout portions 13x11, 13x12, and 13x13 are peeled off in order, so that the sheet-shaped sealer 13x can be removed from the developing case 13r. Further, the sheet-shaped sealer 13x of the present embodiment is detached from the developing case 13r in the order of the fixing portion 13x21, the elastic member 13x5, the fixing portion B of the cutout portion 13x13, the fixing portion B of the cutout portion 13x12, and the fixing portion B of the cutout portion 13x11. Thus, an increase in the pull-out resistance of the sheet-shaped sealer 13x can be prevented, and the operability at the time of pulling-out of the sheet-shaped sealer 13x can be enhanced.

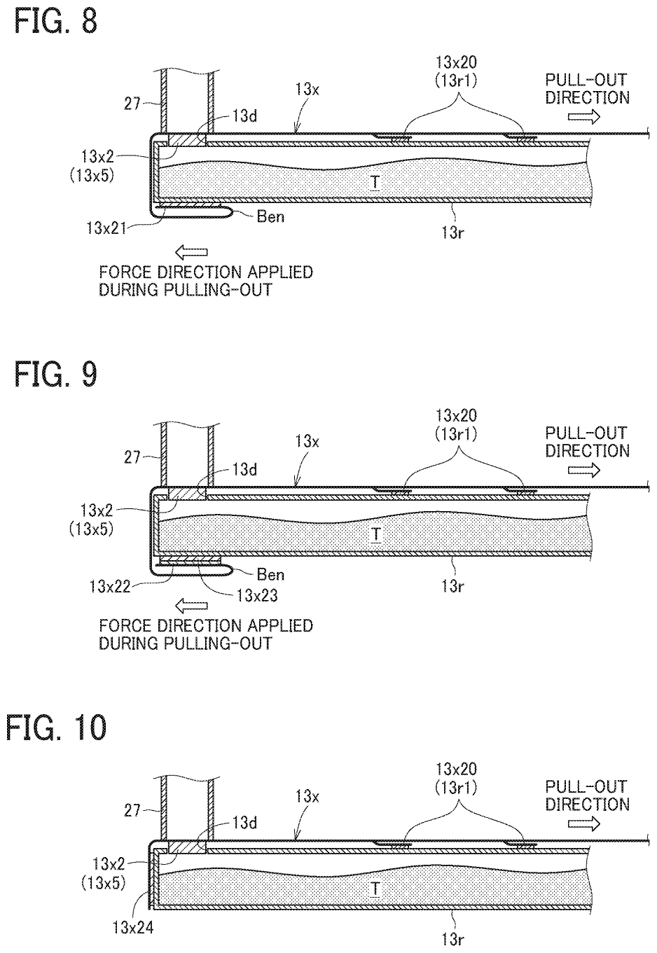

Second Embodiment FIG. 8 is a schematic diagram illustrating a second embodiment of the present disclosure. In the second embodiment, the end of the sheet-shaped sealer 13x on the back side in the pull-out direction is folded back to the developing case 13r at a folded portion Ben, and the fixing portion 13x21 on the upper surface of the folded portion Ben is bonded and fixed to the lower surface of the developing case 13r with, for example, a double-sided tape. The folded portion Ben facilitates the peeling of the fixing portion 13x21 when the sheet-shaped sealer 13x is pulled out, and then, the pull-out resistance of the sheet-shaped sealer 13x is decreased, so that the operability at the time of pulling out can be enhanced.

Third Embodiment FIG. 9 is a schematic diagram illustrating a third embodiment of the present disclosure. In the third embodiment, the double-sided tape of the fixing portion 13x21 in FIG. 8 is formed in two layers. In other words, a fixing portion 13x22 of the lower layer and a fixing portion 13x23 of the upper layer are formed in two layers in FIG. 9.

An adhesive force of the fixing portion 13x23 of the upper layer is smaller than the adhesive force of the fixing portion 13x22 of the lower layer. Such a configuration can reduce an inconvenience that the adhesive on the fixing portion 13x23 of the upper layer remains on the developing case 13r when a user pulls out the sheet-shaped sealer 13x.

In addition to the reduction of an inconvenience of the adhesive remaining, the pull-out resistance of the sheet-shaped sealer 13x can be reduced, and the operability at the time of pulling-out can be enhanced. Instead of forming the double-sided tape on the fixing portion 13x21 in two layers, two types of double-sided tapes having different adhesive forces may be used.

Fourth Embodiment FIG. 10 is a schematic diagram illustrating a fourth embodiment of the present disclosure. In the fourth embodiment, the back side of the sheet-shaped sealer 13x in the pull-out direction is bent in an L-shape. A fixing portion 13x24 provided on the inner surface of the sheet-shaped sealer 13x of the bent portion is bonded and fixed to the tip surface of the developing case 13r with, for example, a double-sided tape. In the fourth embodiment, the length of the sheet-shaped sealer 13x can be shorten as compared with the first, second, and third embodiments, and thus, resources are saved. The fixing portion 13x24 may be formed in two layers as in the third embodiment illustrated in FIG. 9.

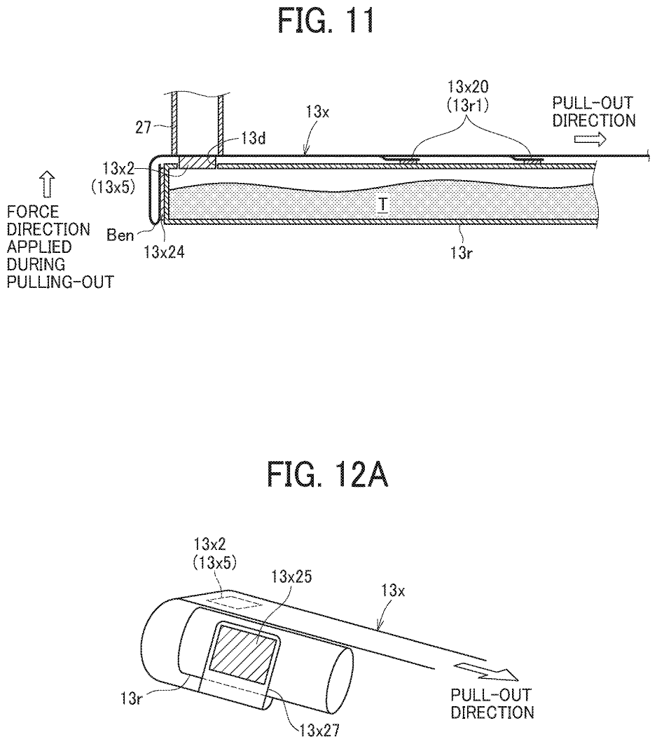

Fifth Embodiment FIG. 11 is a schematic diagram illustrating a fifth embodiment of the present disclosure. In the fifth embodiment, the end on the back side of the sheet-shaped sealer 13x in the pull-out direction is bent in an L-shape, and is folded inward at the folded portion Ben. The fixing portion 13x24 provided on the inner surface of the sheet-shaped sealer 13x of the bent portion is bonded and fixed to the tip surface of the developing case 13r with, for example, a double-sided tape. The folded portion Ben facilitates the peeling of the fixing portion 13x24 when the sheet-shaped sealer 13x is pulled out, and the pull-out resistance of the sheet-shaped sealer 13x is reduced, so that the operability at the time of pulling out can be enhanced. The fixing portion 13x24 may be formed in two layers as in the third embodiment illustrated in FIG. 9.

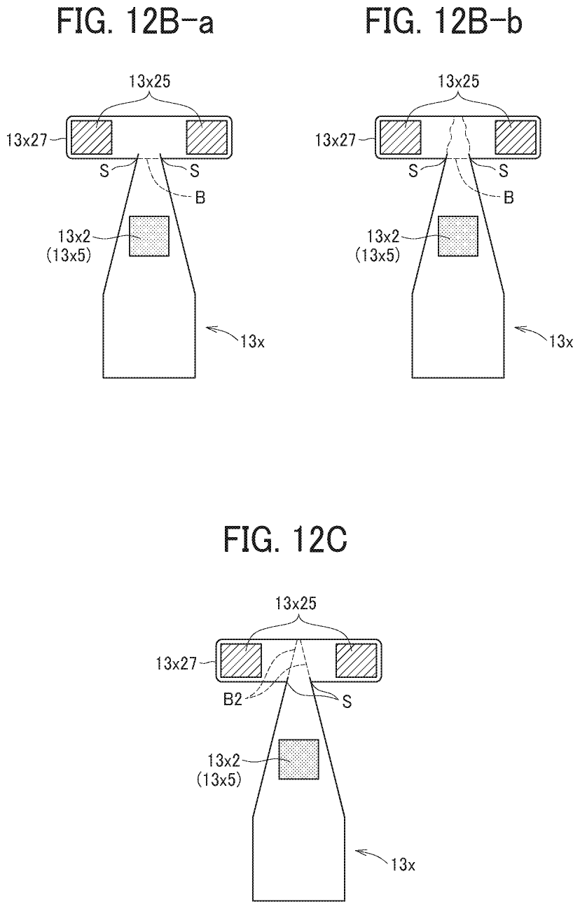

Sixth embodiment FIGS. 12A, 12B, and 12C are schematic diagrams illustrating a sixth embodiment of the present disclosure. In the sixth embodiment, as illustrated in FIG. 12B-a, the sheet-shaped sealer 13x is tapered on the back side in the pull-out direction, and a laterally long tape-shaped portion 13x27 is connected to the tip of the tapered shape.

At both ends of the laterally long tape-shaped portion 13x27, fixing portions 13x25 are disposed by, for example, a double-sided tape. The sealing portion 13x2 is disposed in the middle of the tapered shape in the illustrated example. However, the position of the sealing portion 13x2 is not limited to the intermediate position of the tapered shape. For example, the sealing portion 13x2 may be disposed on the root side of the tapered shape.

A pair of left-and-right slits S are formed in a coupling portion of the tapered shape and the laterally long tape-shaped portion 13x27. The pair of left-and-right slits S are formed to be easily cracked as indicated by dashed lines in FIG. 12B-b. The pair of left-and-right slits S are formed such that the extension lines B2 of the slits S reach one place in an inverted V-shape on the opposite side of the laterally long tape-shaped portion 13x27 as indicated in FIG. 12C.

As illustrated in FIG. 12A, the laterally long tape-shaped portion 13x27 is wound to surround the end of the developing case 13r in a U-shape from the lower side of the developing case 13r. The fixing portions 13x25 are bonded and fixed to both left-and-right lateral surfaces of an end of the developing case 13r.

Accordingly, the laterally long tape-shaped portion 13x27 is firmly fixed to the developing case 13r. As a result, the back side of the sheet-shaped sealer 13x in the pull-out direction can be appropriately tensioned without slack. This moderate tension can prevent the fixing portion 13x25 from being displaced or detached unexpectedly.

When the sheet-shaped sealer 13x is pulled in the pull-out direction in the state illustrated in FIG. 12A, the crack (rupture) progresses from the pair of left-and-right slits S as illustrated in 12B-b. The sheet-shaped sealer 13x is pulled out together with the sealing portion 13x2 while leaving the fixing portion 13x25 and the laterally long tape-shaped portion 13x27. The sheet-shaped sealer 13x ahead of the slits S can be easily separated by the pair of left-and-right slits S, so that the pull-out resistance of the sheet-shaped sealer 13x is decreased, and the operability at the time of pulling-out can be enhanced.

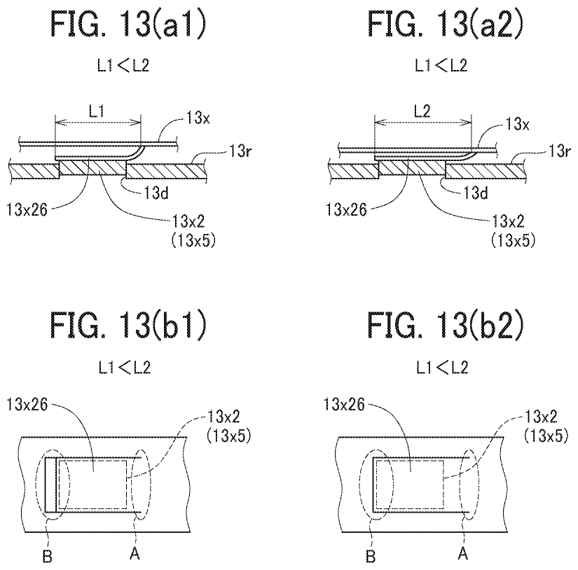

Seventh embodiment FIGS. 13 (a1), 13 (a2), 13 (b1), and 13 (b2) are schematic diagrams illustrating a seventh embodiment of the present disclosure. FIG. 13 (a1) and FIG. 13 (a2) are cross-sectional views of the sheet-shaped sealer 13x. FIG. 13 (b1) and FIG. 13 (b2) are plan views of the sheet-shaped sealer 13x.

In the seventh embodiment, the elastic member 13x5 of the sealing portion 13x2 of the sheet-shaped sealer 13x is bonded and fixed to the lower surface of a cutout portion 13x26. The cutout portion 13x26 is formed by a substantially U-shaped (substantially strip-shaped) cut, similarly to the cutout portion 13x11, 13x12, and 13x13 in FIG. 6.

However, in FIGS. 13 (a1), 13 (a2), 13 (b1), and 13 (b2), the root A and the fixing portion B of the cutout portion 13x26 are arranged in the opposite direction in the pull-out direction. That is, in FIGS. 13 (a1), 13 (a2), 13 (b1), and 13 (b2), the root A of the cutout portion 13x26 is disposed on the front side in the pull-out direction, and the fixing portion B is disposed on the back side in the pull-out direction.

As illustrated in FIGS. 13 (a1) and 13 (b1), in a state where a force in the pull-out direction is not applied to the sheet-shaped sealer 13x, a slack is formed in the vicinity of the root A of the cutout portion 13x26. However, when a force in the pull-out direction acts on the sheet-shaped sealer 13x as illustrated in FIGS. 13 (a2) and 13 (b2), the sheet-shaped sealer 13x approaches the developing case 13r, and the vicinity of the root A of the cutout portion 13x26 is tensed.

The vicinity of the root A of the cutout portion 13x26 is tensed, and at the same time, the fixing portion 13x21 of the end on the back side in the pull-out direction of the sheet-shaped sealer 13x is peeled from the lower surface of the tip portion of the developing case 13r. However, even in this state, the elastic member 13x5 of the sealing portion 13x2 remains fitted to the supply port 13d.

When the sheet-shaped sealer 13x is further pulled in the pull-out direction from the state illustrated in FIGS. 13 (a2) and 13 (b2), the elastic member 13x5 of the sealing portion 13x2 is detached from the supply port 13d. In this manner, the time difference between the peeling of the fixing portion 13x21 and the separation of the elastic member 13x5 can be generated by the cutout portion 13x26 in the seventh embodiment.

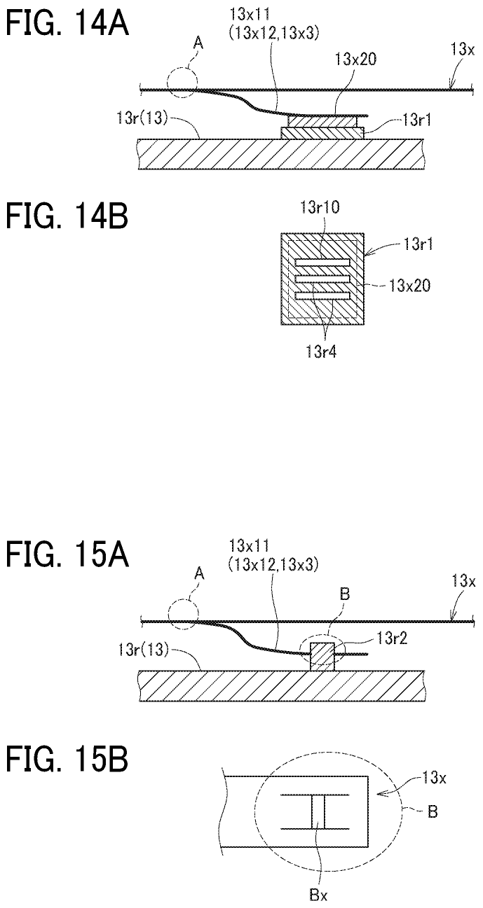

First Modification As illustrated in FIG. 14A, the sheet-shaped sealer 13x in the first modification is also provided with a double-sided tape 13x20 on a surface of the fixing portion B facing the fixed portion 13r1 of the developing case 13r. In the first modification, as illustrated in FIG. 14B, the surface of the fixed portion 13r1 of the developer case 13r (the surface to which the fixing portion B is adhered) has a concave-and-convex portion.

The sheet-shaped sealer 13x is adhered to the fixed portion 13r1 on which the concave-and-convex portion is formed via the double-sided tape 13x20. Specifically, the fixed portion 13r1 is formed to protrude upward from the front face of the developing case 13r. A plurality of recesses 13r10 (grooves) are formed in the fixed portion 13r1.

Such a configuration reduces the contact area between the fixed portion 13r1 and the double-sided tape 13x20. For this reason, even if there is no difference in the adhesive force between the front surface (fixing portion B side) and the back surface (fixed portion 13r1 side) of the double-sided tape 13x20, the adhesive force of the double-sided tape 13x20 with respect to the fixed portion 13r1 can be made smaller than the adhesive force of the double-sided tape 13x20 with respect to the fixing portion B.

Such a configuration can reduce inconveniences that the adhesive of the double-sided tape 13x20 remains on the fixed portion 13r1 when an operator pulls out the sheet-shaped sealer 13x. Further, the pull-out operability is also enhanced.

In particular, in the example of FIGS. 14A and 14B, a plurality of recesses 13r10 (grooves) are formed in the fixed portion 13r1 at intervals in the lateral direction to extend along the pull-out direction (longitudinal direction). Accordingly, the sheet-shaped sealer 13x is relatively strong against the force acting in the lateral direction, and the repulsive force that an operator receives in the pull-out direction is weakened. As a result, a preferable pull-out operability of the sheet-shaped sealer 13x can be obtained while the function of determining the position in the lateral direction is maintained.

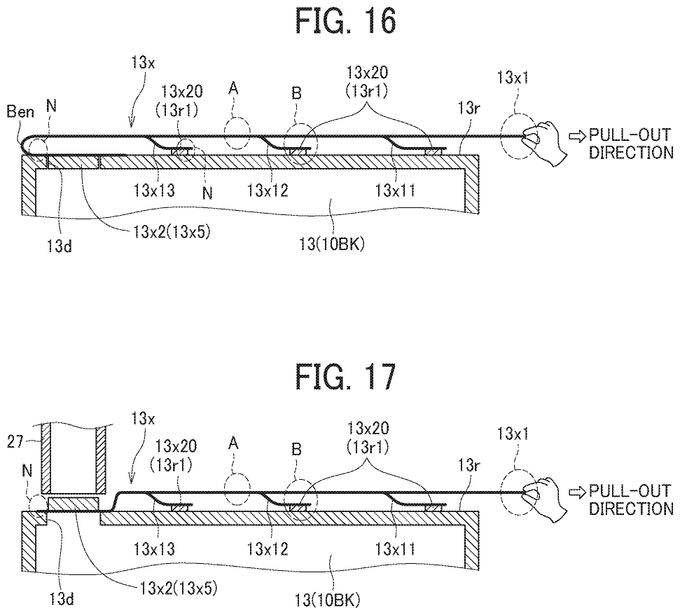

Second Modification As illustrated in FIG. 15A, in a second modification, a fixed portion 13r2 of the developing case 13r is formed in a projection shape (boss shape) to protrude upward from the front face of the developing case 13r. As illustrated in FIG. 16B, the fixing portion B of the sheet-shaped sealer 13x has a slit Bx that can be fitted to the fixed portion 13r2 having a projection shape.

In other words, as illustrated in FIG. 16A, the slit Bx of the fixing portion B is fitted into the fixed portion 13r2, and thus the fixing portion B is fixed to the fixed portion 13r2. Even in a case of such a configuration, the operability at the time of pulling out and the assemblability at the time of assembling can be enhanced in the sheet-shaped sealer 13x. In particular, according to the configuration of the second modification, the double-sided tape 13x20 does not need to be disposed on the fixing portion B. Thus, the fixing portion B can be relatively easily fixed to the fixed portion 13r1.

Third Modification As illustrated in FIG. 16, the end of the sheet-shaped sealer 13x in a third modification on the back side in the pull-out direction is folded back to the lower side (developing case 13r side) at a folded portion Ben. The folded portion Ben is the sealing portion 13x2, and the elastic member 13x5 is bonded to the lower surface of the sealing portion 13x2.

A portion on the left side (back side in the pull-out direction) of the sealing portion 13x2 is thermally welded to an edge portion N of the supply port 13d (opening portion). A thermally welded portion of the edge portion N forms a fixing portion in which the sheet-shaped sealer 13x is bonded and fixed to the developing case 13r as a removable unit on the rear side of the sealing portion 13x2 in the pull-out direction. The elastic member 13x5 may be omitted, and the supply port 13d may be directly sealed by the sealing portion 13x2 itself.

Even in a case of such a configuration, the operability at the time of pulling out and the assemblability at the time of assembling can be enhanced in the sheet-shaped sealer 13x. In particular, according to the configuration of the third modification, the repulsive force at the time of pulling out can be relatively small by the folded portion Ben. When an operator pulls out the sheet-shaped sealer 13x, such a configuration can prevent toner from adhering to the surface of the developing case 13r by the upper surface of the sealing portion 13x2 contaminated with the toner.

Fourth Modification As illustrated in FIG. 17, in the sheet-shaped sealer 13x according to the configuration of a fourth modification, the sealing portion 13x2 is an end on the rear side in the pull-out direction, and a portion on the left side of the sealing portion 13x2 (on the rear side in the pull-out direction) is thermally welded to the edge portion N around the supply port 13d (opening portion). A thermally welded portion of the edge portion N forms a fixing portion in which the sheet-shaped sealer 13x is bonded and fixed to the developing case 13r as a removable unit on the rear side of the sealing portion 13x2 in the pull-out direction. The elastic member 13x5 is bonded to the upper surface of the sealing portion 13x2.

In other words, the sheet-shaped sealer 13x is formed such that the toner discharge port 27 (an opening portion for flowing out toner (powder) toward the supply port 13d) as a sealed portion is sealed by the sealing portion 13x2 (elastic member 13x5) facing upward. Accordingly, in the sheet-shaped sealer 13x in the fourth modification, the fixing portion B of each of the cutout portions 13x11, 13x12, and 13x13 is removably fixed to the fixed portion 13r1 of the housing (developing case 13r) in which the sheet-shaped sealer 13x is installed, and seals the toner discharge port 27 of the toner supply passage installed in the body of the image forming apparatus 1.

When the body of the image forming apparatus 1 is started to be used after the arrival of the image forming apparatus 1, the sheet-shaped sealer 13x is pulled out by an operator. Thus, the toner discharge port 27 and the supply port 13d communicate with each other, so that the image forming process can be executed. Even in a case of such a configuration, the operability at the time of pulling out and the assemblability at the time of assembling can be enhanced in the sheet-shaped sealer 13x.

As described above, the sheet-shaped sealer 13x in this embodiment is provided with the fixing portion 13x21 for fixing the sheet-shaped sealer 13x to the developing case 13r as a mounting unit on the rear side of the sealing portion 13x2. The lifting of the sealing portion 13x2 is prevented by the fixing portion 13x21, so that the interference of the sealing portion 13x2 with the toner discharge port 27 on the body side and coming off can be avoided when the developing case 13r is inserted into the body of the image forming apparatus 1. The sealing portion 13x2 is detached from the supply port 13d after the fixing portion 13x21 is peeled off from the developing case 13r. The cutout portions 13x11, 13x12, and 13x13 having different lengths in the pull-out direction are provided, so that an increase in the pull-out resistance of the sheet-shaped sealer 13x can be prevented, and the operability at the time of pulling-out can be enhanced.

In the present embodiment, the sheet-shaped sealer 13x is detachably installed on the process cartridge 10BK including the photoconductor drum 11 (image bearer), the developing device 13, the charging device 12, and the cleaning device 15. However, the sheet-shaped sealer 13x to which the present disclosure is applied is not limited to this, and the present disclosure can be applied to, for example, a sheet-shaped sealer detachably installed in a removable unit detachably installed in the body of the image forming apparatus 1, for example, a developing unit (developing device 13) detachably installed as a single unit in the body of the image forming apparatus 1.

The sheet-shaped sealer of the present embodiment can be detachably installed not only in the removable unit but also in a device (e.g., the writing device 6) that is installed and fixed in the body of the image forming apparatus 1. Even in such a case, substantially the same effects as the effects in the present embodiment can be obtained. The term “process cartridge” used in the present disclosure is defined as a unit that unites an image bearer and at least one of a charging device to charge the image bearer, a developing device to develop a latent image on the image bearer, and a cleaning device to clean the image bearer, and that is attachable to and detachable from the body of the image forming apparatus.

A sealer includes a sealing portion and a fixing portion. The sealing portion seals a supply port of a removable unit detachable from an apparatus in a pull-out direction. The fixing portion is on the removal unit to fix the sealer to the removable unit. The fixing portion is disposed upstream from the sealing portion in the pull-out direction.

The sealer further includes a grip at a downstream end of the sealer in the pull-out direction. The grip is gripped and pulled out in the pull-out direction to remove the sealer from the removal unit. The sealing portion is disposed upstream from the grip in the pull-out direction, and the fixing portion is disposed upstream from the sealing portion in the pull-out direction.

The sealing portion is detached from the supply port after the fixing portion is detached from the removal unit by pulling the grip in the pull-out direction.

The sealer further includes a tear portion between the sealing portion and the fixing portion. The tear portion is torn by pulling the grip in the pull-out direction to detach the sealing portion from the supply port.

The tear portion has a slit between the sealing portion and the fixing portion.

The sealer further includes a cutout portion cut out from the sealer and has a root connected to the sealer and another fixing portion attached to the free end of the cutout portion.

The sealer has a folded portion in which an upstream end of the sealer in the pull-out direction is folded back. The fixing portion is attached to the folded portion.

The fixing portion includes a first adhesive layer and a second adhesive layer. The first adhesive layer is on the removable unit and has a first adhesive strength. The second adhesive layer is on the sealer and has a second adhesive strength larger than the first adhesive strength.

The supply port is disposed at one side face of the removable unit. The fixing portion is bonded to another side face of the removable unit opposite to the supply port.

The fixing portion is bonded to an upstream end of the removable unit in the pull-out direction.

A removable unit includes the sealer.

An image forming apparatus includes the removable unit.

Note that embodiments of the present disclosure are not limited to the above-described embodiments and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

Aspects of the present disclosure may be, for example, combinations of first to twelfth aspects as follows.

### First Aspect

A sheet-shaped sealer (e.g., the sheet-shaped sealer 13x) has a sealing portion (e.g., the sealing portion 13x2) and a fixing portion (e.g., the fixing portion 13x21). The sealing portion seals a supply port (e.g., the supply port 13d) of a removable unit (e.g., the process cartridges 10Y, 10C, 10M, and 10BK, or the developing case 13r) attachable to and detachable from a body of an image forming apparatus (e.g., the image forming apparatus 1). The sheet-shaped sealer can be pulled out from a front side in a pull-out direction as a longitudinal direction of the removable unit. The sheet-shaped sealer is bonded and fixed on the fixing portion of the removable unit on a back side in the pull-out direction further than the sealing portion.

### Second Aspect

In the sheet-shaped sealer (e.g., the sheet-shaped sealer 13x) according to the first aspect, the sealing portion (e.g., the sealing portion 13x2) is installed on a back side in the pull-out direction of the removable unit (e.g., the process cartridges 10Y, 10C, 10M, and 10BK, or the developing case 13r). The fixing portion (e.g., the fixing portion 13x21) is installed on a back side in the pull-out direction further than the sealing portion (e.g., the sealing portion 13x2).

### Third Aspect

In the sheet-shaped sealer (e.g., the sheet-shaped sealer 13x) according to the first or second aspect, when the sheet-shaped sealer is pulled out in the pull-out direction of the removable unit (e.g., the process cartridges 10Y, 10C, 10M, and 10BK, or the developing case 13r), the sealing portion (e.g., the sealing portion 13x2) is detached from the supply port (e.g., the supply port 13d) after the fixing portion (e.g., the fixing portion 13x21) is peeled off.

### Fourth Aspect

In the sheet-shaped sealer (e.g., the sheet-shaped sealer 13x) according to the first or second aspect, when the sheet-shaped sealer is pulled out in the pull-out direction, the sealing portion (e.g., the sealing portion 13x2) is detached from the supply port (e.g., the supply port 13d) after the sheet-shaped sealer between the sealing portion and the fixing portion (e.g., the fixing portion 13x21) is torn.

### Fifth Aspect

In the sheet-shaped sealer (e.g., the sheet-shaped sealer 13x) according to the fourth aspect, the sheet-shaped sealer is torn starting from a slit (e.g., the slit S) formed in the sheet-shaped sealer between the sealing portion (e.g., the sealing portion 13x2) and the fixing portion (e.g., the fixing portion 13x21).

### Sixth Aspect

The sheet-shaped sealer (e.g., the sheet-shaped sealer 13x) according to any one of the first to fifth aspects further includes a cutout portion (e.g., the cutout portion 13x11, 13x12, 13x13) that is cut out to be cantilevered with a position different from the sealing portion (e.g., the sealing portion 13x2) as a root (e.g., the root A), the fixing portion (e.g., the fixing portion 13x21) is installed on a free end of the cutout portion.

### Seventh Aspect

In the sheet-shaped sealer (e.g., the sheet-shaped sealer 13x) according to any one of the first to sixth aspects, a back end of the sheet-shaped sealer in the pull-out direction is folded back toward the removable unit (e.g., the process cartridges 10Y, 10C, 10M, and 10BK, or the developing case 13r), and the fixing portion (e.g., the fixing portion 13x21) is installed at a folded portion (e.g., the folded portion Ben).

### Eighth Aspect

In the sheet-shaped sealer (e.g., the sheet-shaped sealer 13x) according to any one of the first to seventh aspects, the fixing portion (e.g., the fixing portion 13x21) includes a first adhesive layer and a second adhesive layer having different adhesive forces, the first adhesive layer having a smaller adhesive force is installed on the removable unit (e.g., the process cartridges 10Y, 10C, 10M, and 10BK, or the developing case 13r), and the second adhesive layer having a larger adhesive force is installed on the sheet-shaped sealer.

### Ninth Aspect

In the sheet-shaped sealer (e.g., the sheet-shaped sealer 13x) according to any one of the first to eighth aspects, the fixing portion (e.g., the fixing portion 13x21) is bonded and fixed to the removable unit (e.g., the process cartridges 10Y, 10C, 10M, and 10BK, or the developing case 13r) on a side opposite to the supply port (e.g., the supply port 13d).

### Tenth Aspect

In the sheet-shaped sealer (e.g., the sheet-shaped sealer 13x) according to any one of the first to eighth aspects, the fixing portion (e.g., the fixing portion 13x21) is bonded and fixed to an end of the removable unit (e.g., the process cartridges 10Y, 10C, 10M, and 10BK, or the developing case 13r) in a longitudinal direction.

### Eleventh Aspect

A removable unit (e.g., the process cartridges 10Y, 10C, 10M, and 10BK, or the developing case 13r) includes the sheet-shaped sealer (e.g., the sheet-shaped sealer 13x) according to any one of the first to tenth aspects.

### Twelfth Aspect

An image forming apparatus (e.g., the image forming apparatus 1) includes the removable unit (e.g., the process cartridges 10Y, 10C, 10M, and 10BK, or the developing case 13r) according to the eleventh aspect.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A sealer comprising:
a sealing portion to seal a supply port of a removable unit detachable from an apparatus in a pull-out direction; and
a fixing portion on the removal unit to fix the sealer to the removable unit,
wherein the fixing portion is disposed upstream from the sealing portion in the pull-out direction.

2. The sealer according to claim 1, further comprising:
a grip at a downstream end of the sealer in the pull-out direction, and
the grip to be gripped and pulled out in the pull-out direction to remove the sealer from the removal unit,
wherein the sealing portion is disposed upstream from the grip in the pull-out direction, and
the fixing portion is disposed upstream from the sealing portion in the pull-out direction.

3. The sealer according to claim 2,
wherein the sealing portion is detached from the supply port after the fixing portion is detached from the removal unit by pulling the grip in the pull-out direction.

4. The sealer according to claim 1, further comprising a tear portion between the sealing portion and the fixing portion,
wherein the tear portion is torn by pulling the grip in the pull-out direction to detach the sealing portion from the supply port.

5. The sealer according to claim 4,
wherein the tear portion has a slit between the sealing portion and the fixing portion.

6. The sealer according to claim 1, further comprising:
a cutout portion cut out from the sealer, the cutout portion having:
a root connected to the sealer; and
a free end movable from the sealer; and
another fixing portion attached to the free end of the cutout portion.

7. The sealer according to claim 1,
wherein the sealer has a folded portion in which an upstream end of the sealer in the pull-out direction is folded back, and
the fixing portion is attached to the folded portion.

8. The sealer according to claim 1,
wherein the fixing portion includes:
a first adhesive layer on the removable unit, the first adhesive layer having a first adhesive strength; and
a second adhesive layer on the sealer,
the second adhesive layer having a second adhesive strength larger than the first adhesive strength.

9. The sealer according to claim 1,
wherein the supply port is disposed at one side face of the removable unit, and
the fixing portion is bonded to another side face of the removable unit opposite to the supply port.

10. The sealer according to claim 4,
wherein the fixing portion is bonded to an upstream end of the removable unit in the pull-out direction.

11. A removable unit comprising the sealer according to claim 1.

12. An image forming apparatus comprising the removable unit according to claim 11.
